(19) United States
(12) Patent Application Publication
(10) Pub. No.: US 2013/0074558 A1
(43) Pub. Date: Mar. 28, 2013

(54) FORGING PRESS AND METHOD OF CONTROLLING SAME

(71) Applicant: Masashi TADO, Ehime (JP)

(72) Inventor: Masashi TADO, Ehime (JP)

(73) Assignee: SUMITOMO HEAVY INDUSTRIES TECHNO-FORT CO., LTD.

(21) Appl. No.: 13/625,103

(22) Filed: Sep. 24, 2012

(30) Foreign Application Priority Data
Sep. 28, 2011 (JP) 2011-211763

(51) Int. Cl. B21J 9/20; B30B 15/14

(52) U.S. Cl. 72/29.2

(57) ABSTRACT

A forging press includes a slide configured to have a die attached thereto; a drive shaft configured to cause the slide to rise and lower by rotating; a flywheel connected to the drive shaft via a clutch; a servomotor and an electric generator each connected to the drive shaft; an electricity storage part configured to store the electricity generated by the electric generator and to feed the servomotor with electric power; and a control part configured to control the operations of the clutch, the servomotor, and the electric generator. The control part performs such control as to cause the electric generator to generate the electricity with the rotation of the drive shaft and to store the generated electricity in the electricity storage part during the rotation of the drive shaft with the driving of the flywheel and/or during the rotation of the drive shaft with an inertial force.

### CROSS-REFERENCE TO RELATED APPLICATION

This application is based upon and claims the benefit of priority of the prior Japanese Patent Application No. 2011-211763, filed on Sep. 28, 2011, the entire contents of which are incorporated herein by reference.

### BACKGROUND OF THE INVENTION

1. Field of the Invention

The present invention relates generally to forging presses and methods of controlling the same, and more particularly to a forging press that includes both a flywheel and a servomotor as a drive source to cause an eccentric shaft to rotate and to a method of controlling the same.

2. Description of the Related Art

As a machine press that causes a slide to be moved upward and downward by the rotation of an eccentric shaft, a hybrid press has been proposed that includes both a flywheel and a servomotor as a drive source to cause the eccentric shaft to rotate.

The hybrid press described above includes a flywheel connected to an eccentric shaft via a clutch and a servomotor connected to the eccentric shaft via a clutch and brake unit. The hybrid press is described as being capable of increasing productivity by increasing the lowering speed and the rising speed of a slide by performing pressure forming with the rotational energy of the flywheel and causing the slide to move upward and downward before and after pressure forming with the servomotor.

### SUMMARY OF THE INVENTION

According to an aspect of the present invention, a forging press includes a slide configured to have a die attached thereto; a drive shaft configured to cause the slide to rise and lower by rotating; a flywheel connected to the drive shaft via a clutch; a servomotor connected to the drive shaft; an electric generator connected to the drive shaft; an electricity storage part configured to store the electricity generated by the electric generator and to feed the servomotor with electric power; and a control part configured to control respective operations of the clutch, the servomotor, and the electric generator, wherein the control part is configured to perform such control as to cause the electric generator to generate the electricity with rotation of the drive shaft and to store the generated electricity in the electricity storage part during at least one of the rotation of the drive shaft with driving of the flywheel and the rotation of the drive shaft with an inertial force.

According to an aspect of the present invention, a method of controlling a forging press including a slide configured to have a die attached thereto, a drive shaft configured to cause the slide to rise and lower by rotating, a flywheel connected to the drive shaft via a clutch, a servomotor connected to the drive shaft, an electric generator connected to the drive shaft, and an electricity storage part configured to store the electricity generated by the electric generator and to feed the servomotor with electric power includes causing the electric generator to generate the electricity with rotation of the drive shaft and storing the generated electricity in the electricity storage part during at least one of the rotation of the drive shaft with driving of the flywheel and the rotation of the drive shaft with an inertial force.

The object and advantages of the embodiments will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram illustrating a forging press that is an embodiment of the present invention;

FIG. 2 is a diagram illustrating a method of controlling the forging press of FIG. 1;

FIG. 3 is a schematic diagram illustrating a forging press that is another embodiment of the present invention; and

FIG. 4 is a diagram illustrating a method of controlling the forging press of FIG. 3.

### DETAILED DESCRIPTION OF THE PREFERRED EMBODIMENTS

According to the above-described conventional technique, however, pressure forming is performed at low speed using the rotational energy of the flywheel. Therefore, the above-described conventional technique is not suitable for hot forging because a high pressing speed is desired for hot forging. Further, the flywheel rotates at a substantially constant speed, which prevents a slide motion during forming from being set as desired. Accordingly, the above-described conventional technique is not suitable for forming a complex shape.

Therefore, the inventor of the present invention has made a study of increasing the pressing speed and setting a slide motion as desired by performing pressure forming with the servomotor in a hybrid press.

In performing pressure forming with the servomotor, there is a problem in that it is necessary to increase the capacity of a power supply for driving the servomotor in order to increase the pressing speed. In particular, it has been found that in the case where high energy is necessary for pressure forming, a power supply capacity becomes considerably large to an unrealistic extent. Conversely speaking, realistic designing is more possible if reduction of a power supply capacity can be achieved.

According to an aspect of the present invention, a forging press and a method of controlling the forging press are provided that make it possible to reduce the capacity of a power supply for driving a servomotor.

A forging press and a method of controlling the forging press according to an aspect of the present invention make it possible to reduce the capacity of a power supply for driving a servomotor.

A description is given below, with reference to the accompanying drawings, of embodiments of the present invention.

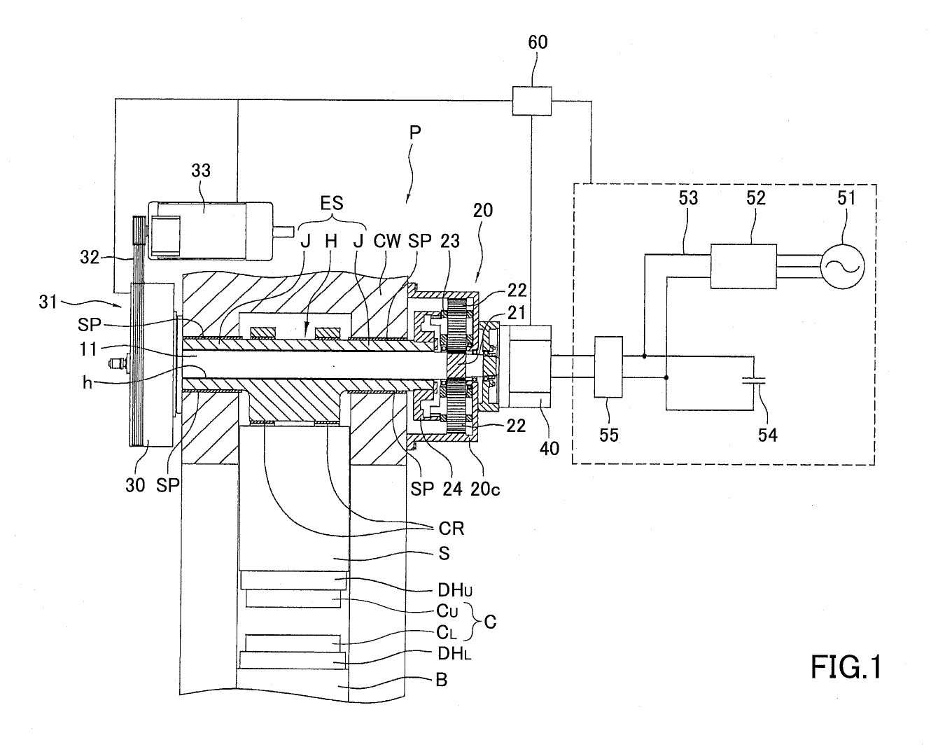

First, a description is given, with reference to FIG. 1, of an overall structure of a forging press P that is an embodiment of the present invention.

Referring to FIG. 1, the forging press P includes a bed B, a lower die holder DHL, an upper die holder DHU, a slide S, connecting rods CR, an eccentric shaft ES, a crown CW, a transmission shaft 11, a transmission part 20, a flywheel 30, and a servomotor 40. A lower die CL of a die C is attached to the upper surface of the lower die holder DHL provided on the upper surface of the bed B. An upper die CU of the die C is attached to the lower surface of the upper die holder DHU provided on the lower surface of the slide S.

The slide S is connected to an eccentric part H of the eccentric shaft (drive shaft) ES via the connecting rods CR. The eccentric shaft ES has a pair of journal parts J rotatably supported by the crown CW. The eccentric shaft ES is a so-called fully eccentric crank shaft, and has the journal parts J provided across the eccentric part H from each other. The journal parts J are concentric and have the same diameter. The eccentric shaft ES has the journal parts J rotatably supported by support parts SP of the crown CW, and is connected to a drive mechanism to be described below. The support parts SP are formed of bushes, etc.

Therefore, the eccentric shaft ES is caused to rotate by the drive mechanism to cause the slide S to move upward and downward, so that when the slide S moves downward, a material (an item to be formed) is sandwiched between the upper die CU and the lower die CL of the die C to be forged.

Next, a description is given of the drive mechanism of the forging press P.

As illustrated in FIG. 1, a shaft placement hole h is formed in the eccentric shaft ES. The shaft placement hole h is a through hole penetrating through the eccentric shaft ES between its shaft ends. The shaft placement hole h penetrates through the journal parts J and the eccentric part H. The central axis of the shaft placement hole h is aligned with the central axis of the journal parts J. That is, the shaft placement hole h is concentric with the journal parts J.

The transmission shaft 11 is provided inside the shaft placement hole h. The transmission shaft 11 has a shaft diameter slightly smaller than the inside diameter of the shaft placement hole h. A case 20c of the below-described transmission part 20 and a body part of a clutch and brake unit 31 cause the central axis of the transmission shaft 11 to be aligned with the central axis of the shaft placement hole h. In other words, the transmission shaft 11 is concentric with the journal parts J of the eccentric shaft ES, and is held to be rotatable relative to the eccentric shaft ES.

Further, the transmission shaft 11 is formed to have such a length as to have both of its ends projecting from the corresponding ends of the eccentric shaft ES when provided in the shaft placement hole h of the eccentric shaft ES. The transmission shaft 11 has one end (the right end in FIG. 1) connected to the transmission part 20, which is a known planetary gear speed reducer.

A sun gear 21 of the transmission part 20 is fixed to a portion of the transmission shaft 11 projecting from the right end of the eccentric shaft ES. Multiple planet gears 22 mesh with the sun gear 21. The planet gears 22 mesh with teeth provided on the interior surface of the case 20c of the transmission part 20. The planet gears 22 are attached to a rotating member 23 so that their respective central axes are equidistant from the central axis of the transmission shaft 11. The rotating member 23 is rotatably supported on the transmission shaft 11 via a bearing or the like. Further, the rotating member 23 is connected by a gear coupling to a driven member 24 fixed to the right end of the eccentric shaft ES.

Therefore, when the transmission shaft 11 rotates, the multiple planet gears 22 revolve around the sun gear 21 while rotating, so that the rotating member 23 rotates on the central axis of the transmission shaft 11. Since the rotating member 23 and the driven member 24 rotate, being connected by a gear coupling, the eccentric shaft ES rotates on its central axis together with the driven member 24.

By adjusting the numbers of teeth of the sun gear 21 and the planet gears 22, it is possible to reduce the ratio of the number of turns of the eccentric shaft ES to the number of turns of the transmission shaft 11 to a predetermined value. Therefore, it is possible to cause high torque to be generated at the eccentric shaft ES.

The flywheel 30 including the clutch and brake unit 31 is attached to a portion of the transmission shaft 11 projecting from the left end of the eccentric shaft ES. The body part of the clutch and brake unit 31 is fixed to the crown CW. The clutch and brake unit 31 is so configured as to connect the flywheel 30 and the transmission shaft 11 when the clutch of the clutch and brake unit 31 is engaged. The flywheel 30 is connected via a V belt 32 to the main shaft of a flywheel (FW) motor 33 that serves as a power source. Therefore, when the clutch is engaged while the FW motor 33 is in operation, it is possible to transmit the driving of the flywheel 30 to the transmission shaft 11. Further, when the clutch is disengaged, the flywheel 30 and the transmission shaft 11 are disconnected, so that the driving of the flywheel 30 is prevented from being transmitted to the transmission shaft 11.

When the brake of the clutch and brake unit 31 is put into operation, the crown CW and the transmission shaft 11 are connected via the body part of the clutch and brake unit 31, so that the rotational speed of the transmission shaft 11 is reduced and the rotation of the transmission shaft 11 may be stopped.

In addition to the transmission part 20, the servomotor 40 is connected to the portion of the transmission shaft 11 projecting from the right end of the eccentric shaft ES. The transmission shaft 11 and the servomotor 40 are connected by the main shaft of the servomotor 40 directly connecting to the transmission shaft 11.

Next, a description is given of a power supply system of the servomotor 40.

The power supply system of the servomotor 40 includes a power supply 51 that generates alternating-current (AC) power, a converter 52 connected to the power supply 51, a converter 55 connected to the servomotor 40, a bus 53 that connects the converter 52 and the converter 55, and a capacitor 54 (an electricity [electric energy] storage part) connected in parallel with the converter 52 to the bus 53. The converter 52 converts AC electric power fed from the power supply 51 into direct-current (DC) electric power. The converter 55 converts DC electric power fed from the converter 52 or the capacitor 54 into AC electric power. The converter 55 converts AC electric power fed from the servomotor 40 into DC electric power.

Therefore, the servomotor 40 may be driven with electric power fed from both or one of the power supply 51 and the capacitor 54. Further, as described below, in the case of causing the servomotor 40 to operate as an electric generator, the electricity generated by the servomotor 40 may be stored in the capacitor 54. In addition to the capacitor 54, a rechargeable battery may also be used as the electricity storage part.

The FW motor 33 may be driven with electric power fed from a power supply (not graphically illustrated) of the same system as the power supply 51 connected to the servomotor 40 or of a system different from that of the power supply 51.

The forging press P further includes a control part 60. The control part 60 controls the engagement and disengagement of the clutch and the operation of the brake of the clutch and brake unit 31, and controls the operation of the FW motor 33, the operation of the servomotor 40, and the operation of the power supply system of the servomotor 40. The control part 60 performs the below-described switching of the operation of the flywheel 30 and the operation of the servomotor 40.

As described above, the forging press P includes both the flywheel 30 and the servomotor 40 as a drive source to cause the eccentric shaft ES to rotate. Accordingly, the forging press P is a so-called hybrid press.

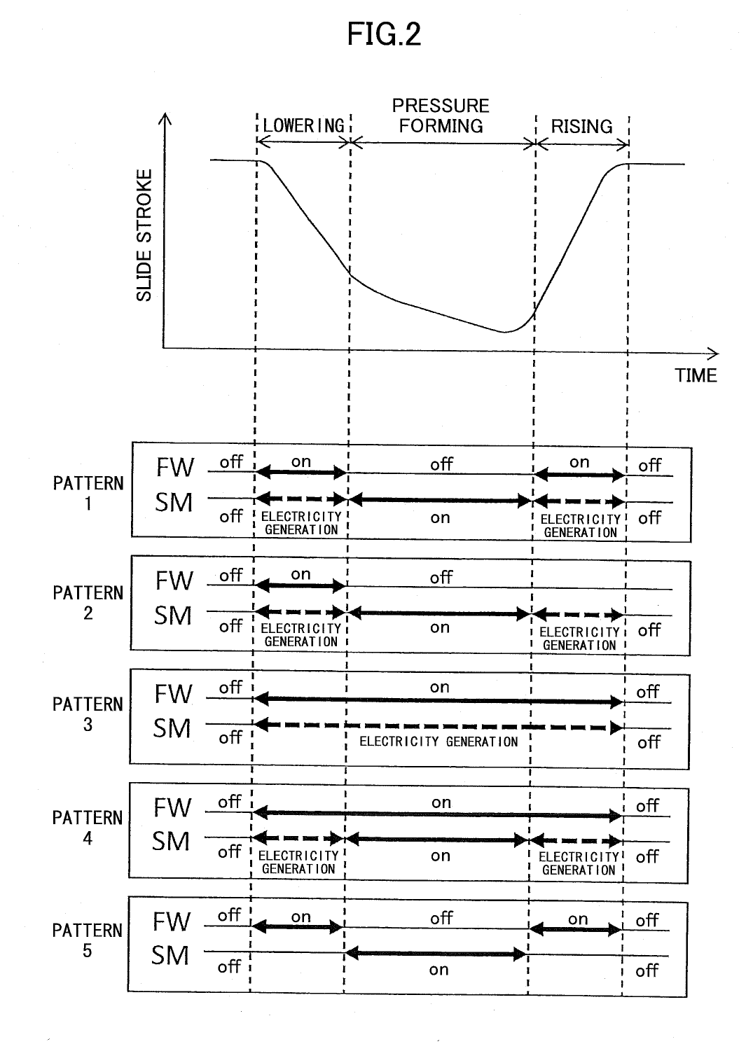

Next, a description is given, with reference to FIG. 2, of a method of controlling the forging press P.

FIG. 2 illustrates a basic slide motion of a press. One cycle of a slide motion is roughly divided into three processes of lowering, pressure forming, and rising. The lowering process, in which the slide S lowers, is a process from the start of the lowering of the slide S from the uppermost point (for example, the top dead center) of a stroke up to the contact of the upper die CU with a material. The pressure forming process, in which the material is subjected to pressure forming using the upper die CU and the lower die CL, is a process from the contact of the upper die CU with the material up to the separation of the upper die CU from the material after the slide S reaching the lowermost point (for example, bottom dead center) of the stroke. The rising process, in which the slide S rises, is a process from the separation of the upper die CU from the material up to the slide S rising to the uppermost point of the stroke.

According to an aspect of the invention, the operation of the flywheel 30 and the operation of the servomotor 40 are switched in the processes. In FIG. 2,

Patterns 1 through 5 illustrate operation patterns of the flywheel 30 and the servomotor 40.

In FIG. 2, FW denotes the flywheel 30 and SM denotes the servomotor 40. In a process where the flywheel 30 is “off,” the clutch of the clutch and brake unit 31 is disengaged, so that the driving of the flywheel 30 is prevented from being transmitted to the transmission shaft 11. In a process where the flywheel 30 is “on,” the clutch of the clutch and brake unit 31 is engaged, so that the driving of the flywheel 30 is transmitted to the transmission shaft 11. In a process where the servomotor 40 is “off,” the servomotor 40 is fed with electric power from neither the power supply 51 nor the capacitor 54, so that the servomotor 40 is caused to rotate by the transmission shaft 11 or is stopped together with the transmission shaft 11. In a process where the servomotor 40 is “on,” the servomotor 40 is fed with electric power from both or one of the power supply 51 and the capacitor 54, so that the driving of the servomotor 40 is transmitted to the transmission shaft 11. Further, in an electricity generation process where the servomotor 40 is caused to operate as an electric generator, the servomotor 40 is caused to rotate by the rotation of the transmission shaft 11 to generate electricity, and the electricity generated by the servomotor 40 is stored in the capacitor 54.

A description is given below of Patterns 1 through 5.

### [Pattern 1]

First, in the lowering process, the clutch of the clutch and brake unit 31 is engaged, so that the driving of the flywheel 30 causes the transmission shaft 11 and the eccentric shaft ES to rotate to lower the slide S. During this operation, the servomotor 40 is caused to operate as an electric generator. That is, the servomotor 40 is caused to rotate by the rotation of the transmission shaft 11 to generate electricity, and the electricity generated by the servomotor 40 is stored in the capacitor 54.

In general, the rotational energy of the flywheel 30 is much higher than starting energy necessary for starting the stationary slide S. Accordingly, it is possible to cause the servomotor 40 to generate electricity and to store the generated electricity in the capacitor 54 while causing the slide S to lower with the driving of the flywheel 30.

Next, in the pressure forming process, the clutch of the clutch and brake unit 31 is disengaged. Then, pressure forming is performed by causing the transmission shaft 11 and the eccentric shaft ES to rotate with the driving of the servomotor 40. At this point, the servomotor 40 is fed with electric power from the capacitor 54. Further, if the electric power of the capacitor 54 is insufficient, the servomotor 40 is also fed with electric power from the power supply 51.

Thus, pressure forming due to the driving of the servomotor 40 may be performed using the energy stored in the preceding lowering process. Therefore, it is possible to prevent an increase in the capacity of the power supply 51 while increasing the pressing speed. Further, since pressure forming is performed using the servomotor 40 whose rotational speed may be freely adjusted, it is possible to determine the slide motion during pressure forming as desired. Therefore, this is suitable for hot forging, for which a high pressing speed is desired, and the formation of a complicated shape.

Next, in the rising process, the clutch of the clutch and brake unit 31 is engaged, so that the driving of the flywheel 30 causes the transmission shaft 11 and the eccentric shaft ES to rotate to raise the slide S. During this operation, the servomotor 40 is caused to operate as an electric generator. That is, the servomotor 40 is caused to rotate by the rotation of the transmission shaft 11 to generate electricity, and the electricity generated by the servomotor 40 is stored in the capacitor 54.

In general, the rotational energy of the flywheel is much higher than energy necessary for causing the stationary slide S to rise. Accordingly, it is possible to cause the servomotor 40 to generate electricity and to store the generated electricity in the capacitor 54 while causing the slide S to rise with the driving of the flywheel 30.

### [Pattern 2]

The lowering process and the pressure forming process of Pattern 2 are the same as those of Pattern 1.

In the rising process of Pattern 2, the clutch of the clutch and brake unit 31 is disengaged. Although the clutch is disengaged, the transmission shaft 11 and the eccentric shaft ES are caused to rotate with the inertial force of the driven system, so that the slide S is caused to rise. Here, the driven system includes parts caused to operate by the drive system of the flywheel 30 and/or the servomotor 40, such as the transmission shaft 11, the eccentric shaft ES, the connecting rods CR, the slide S, the upper die holder DHU, and the upper die CU. Meanwhile, the servomotor operates as an electric generator. That is, the servomotor 40 is caused to rotate by the rotation of the transmission shaft 11 to generate electricity, and the electricity generated by the servomotor 40 is stored in the capacitor 54.

In general, when the slide S approaches the uppermost point, the brake of the clutch and brake unit 31 is put into operation to reduce the rising speed of the slide S, and in some cases, the slide S is caused to stop at the uppermost point.

Meanwhile, by causing the servomotor 40 to generate electricity while the slide S is rising with the inertial force as described above, it is possible to brake the slide S while converting the inertial energy of the driven system into electricity and storing the electricity. That is, the servomotor 40 may be used as a regenerative brake.

### [Pattern 3]

Pattern 3 is a pattern where in the pressure forming process of Pattern 1, the transmission shaft 11 and the eccentric shaft ES are caused to rotate with the driving of the flywheel 30, so that the servomotor 40 generates electricity and the generated electricity is stored in the capacitor 54. That is, throughout one cycle of the slide motion, the transmission shaft 11 and the eccentric shaft ES are caused to rotate with the driving of the flywheel 30, so that the servomotor 40 generates electricity and the generated electricity is stored in the capacitor 54.

In general, the rotational energy of the flywheel 30 is much higher than energy necessary for causing the slide S to lower or rise or performing pressure forming. Accordingly, it is possible to cause the servomotor 40 to generate electricity and to store the generated electricity in the capacitor 54 while driving the slide S with the flywheel 30.

Further, it is possible to ensure a long period of time for electricity generation by the servomotor 40. Accordingly, when the level of electricity (energy) stored in the capacitor 54 is low, an early recovery of the level of stored electricity is possible.

### [Pattern 4]

Pattern 4 is a pattern where pressure forming in the pressure forming process of Pattern 1 is performed by causing the transmission shaft 11 and the eccentric shaft ES to rotate with the driving of both the flywheel and the servomotor 40.

Depending on a material to be processed or a shape to be formed, the servomotor 40 alone may not provide sufficient torque or energy for pressure forming. In this case, by performing driving with both the flywheel 30 and the servomotor 40, it is possible to supply torque or energy sufficient for pressure forming.

### [Pattern 5]

Pattern 5 is a pattern where the servomotor 40 is neither fed with electric power nor caused to generate electricity in the lowering process and the rising process of Pattern 1.

For example, in a large-size press, the inertial mass of the driven system is so large that extremely high torque or energy may be necessary to start the slide S in a stationary state. In this case, it is possible to start the slide S by reducing clutch torque by stopping electricity generation by the servomotor 40.

Thus, according to the method of controlling the forging press P that is an embodiment of the present invention, the servomotor 40 may be caused to rotate by the transmission shaft 11, which is caused to rotate with the driving of the flywheel 30 or with an inertial force, to generate electricity, and the generated electricity may be stored in the capacitor 54. Further, the servomotor 40 may be driven using the electricity stored in the capacitor 54, which makes it possible to reduce the capacity of the power supply 51 for driving the servomotor 40. This allows realistic designing of the forging press P. Further, the servomotor 40 converts an excess rotational energy of the flywheel 30 or the inertial energy of the driven system into electricity. Therefore, it is possible to make efficient use of energy in the forging press P as a whole.

In the above description of Patterns 1 through 5, the engagement and disengagement of the clutch of the clutch and brake unit 31 and the operation of the servomotor 40 are switched at the boundaries of the lowering process, the pressure forming process, and the rising process. However, the engagement and disengagement of the clutch and the operation of the servomotor 40 may be switched before or after the boundaries of the individual processes in terms of time.

At the time of engaging the clutch, the impact of the clutch may be reduced by matching the rotational speed of the transmission shaft 11 due to the servomotor 40 with the rotational speed of the flywheel 30. Therefore, by causing the engagement and disengagement of the clutch and the operation of the servomotor 40 to be switched before or after the boundaries of the individual processes in terms of time, it is possible to reduce the impact of the clutch by matching the rotational speed of the transmission shaft 11 with the rotational speed of the flywheel 30.

Further, in view of safety demand, the clutch of the clutch and brake unit 31 may be disengaged before the stoppage of the slide S at the uppermost point in the respective rising processes of Patterns 1 through 5 described above.

Further, press working may be performed continuously by repeating any one of Patterns 1 through 5 described above. Alternatively, press working may be performed with a pattern different from cycle to cycle. For example, in a transfer press that has multiple dies and feeds a material to the dies of subsequent processes in a sequential manner using a transfer feeder, it is preferable to perform control with an optimum pattern that suits a forming method cycle by cycle. In this case, the electricity stored in the capacitor 54 in one pattern may be used to drive the servomotor 40 in another pattern.

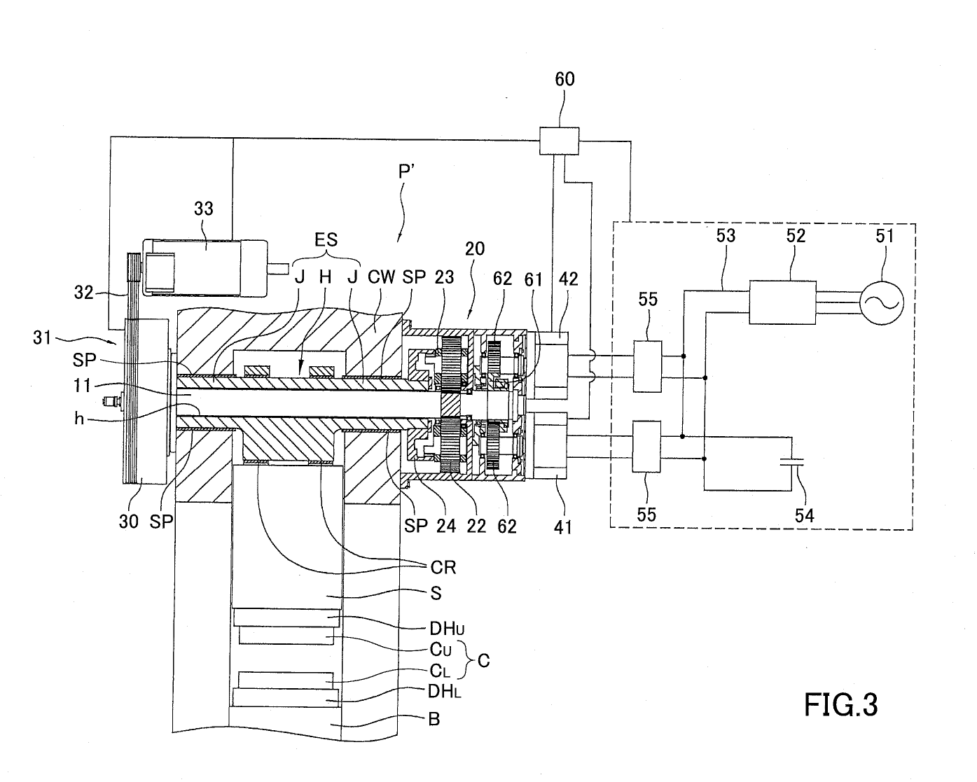

Next, a description is given, with reference to FIG. 3, of a forging press P′ that is another embodiment of the present invention.

The forging press P′ that is another embodiment of the present invention includes a main gear 61 fixed to the right end of the transmission shaft 11 and multiple driving gears 62 that mesh with the main gear 61. The main shafts of servomotors 41 and 42, which are fixed to the crown CW with a frame or the like, are connected to the respective driving gears 62. This allows the transmission shaft 11 to be fed with driving forces from the multiple servomotors 41 and 42. Therefore, even if the driving force generated by each of the servomotors 41 and 42 is small, it is possible to feed the transmission shaft 11 with a large driving force.

Otherwise, the forging press P′ has the same configuration as the above-described forging press P that is an embodiment of the present invention. Accordingly, the same members as those of the forging press P are referred to by the same reference numerals, and a description thereof is omitted.

A power supply system for the servomotors 41 and 42 is formed by connecting the servomotors 41 and 41 in parallel to the bus 53 (through the corresponding converters 55) in the power supply system of the above-described forging press P that is an embodiment of the present invention.

Therefore, the servomotors 41 and 42 may be driven with electric power fed from both or one of the power supply 51 and the capacitor 54. Further, in the case of causing the servomotors 41 and 42 to operate as electric generators, the electricity generated by the servomotors 41 and 42 may be stored in the capacitor 54.

In the forging press P′ as well, the same control may be performed as in the above-described forging press P that is an embodiment of the present invention.

Therefore, the servomotors 41 and 42 may be driven using the electricity stored in the capacitor 54, which makes it possible to reduce the capacity of the power supply 51 for driving the servomotors 41 and 42. This allows realistic designing of the forging press P′. Further, the servomotors 41 and 42 convert an excess rotational energy of the flywheel 30 or the inertial energy of the driven system into electricity. Therefore, it is possible to make efficient use of energy in the forging press P′ as a whole.

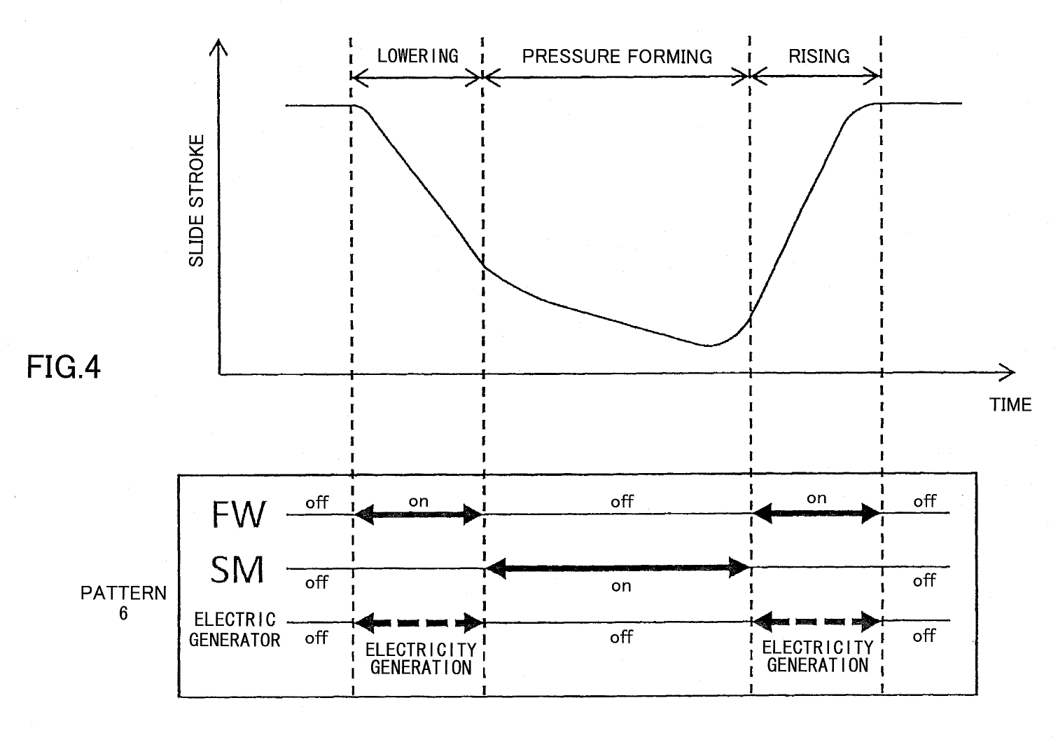

Further, in the case of using one of the servomotors 41 and 42 only as an electric generator or in the case of replacing one of the servomotors 41 and 42 with an electric generator, the control of Pattern 6 as illustrated in FIG. 4 may be performed in addition to Patterns 1 through 5 described above. The following description is given, assuming that the servomotor 41 operates as a servomotor and the servomotor 42 operates and is referred to as an electric generator.

### [Pattern 6]

First, in the lowering process, the clutch of the clutch and brake unit 31 is engaged, so that the transmission shaft 11 and the eccentric shaft ES are caused to rotate with the driving of the flywheel 30 to cause the slide S to lower. During this operation, the servomotor 41 is fed with no electric power and is caused to rotate by the rotation of the transmission shaft 11. Meanwhile, the electric generator 42 is caused to rotate by the rotation of the transmission shaft 11 to generate electricity, and the electricity generated in the electric generator 42 is stored in the capacitor 54.

Next, in the pressure forming process, the clutch of the clutch and brake unit 31 is disengaged, and pressure forming is performed by causing the transmission shaft 11 and the eccentric shaft ES to rotate with the driving of the servomotor 41. At this point, the servomotor 41 is fed with electric power from the capacitor 54. If the electric power of the capacitor 54 is insufficient, the servomotor 41 is also fed with electric power from the power supply 51. The electric generator 42 is so controlled as to generate no electricity.

Next, in the rising process, the clutch of the clutch and brake unit 31 is engaged, so that the transmission shaft 11 and the eccentric shaft ES are caused to rotate with the driving of the flywheel 30 to cause the slide S to rise. During this operation, the servomotor 41 is fed with no electric power, and is caused to rotate by the rotation of the transmission shaft 11. Meanwhile, the electric generator 42 is caused to rotate by the rotation of the transmission shaft 11 to generate electricity, and the electricity generated in the electric generator 42 is stored in the capacitor 54.

Thus, by providing the servomotor 41 and the electric generator 42 separately, it is possible to generate electricity with the electric generator 42 at any time independent of the operation of the servomotor 41.

Meanwhile, causing the servomotor 40 to operate as an electric generator as in the above-described forging press P that is an embodiment of the present invention eliminates the necessity of providing an electric generator separately from the servomotor 40. This makes it possible to make the forging press P compact as a whole.

A forging press according to an aspect of the present invention may have any configuration as long as a flywheel and a servomotor are connected to a drive shaft that causes a slide to rise and lower. For example, in the above-described embodiments of the present invention, the flywheel 30 and the servomotor 40 (41, 42) may be connected to the eccentric shaft ES without the transmission shaft 11 and the transmission part 20. Further, the servomotor 40 (41, 42) and the drive shaft may be connected via a clutch.

A forging press according to an aspect of the present invention includes a slide configured to have a die attached thereto; a drive shaft configured to cause the slide to rise and lower by rotating; a flywheel connected to the drive shaft via a clutch; a servomotor connected to the drive shaft; an electric generator connected to the drive shaft; an electricity storage part configured to store the electricity generated by the electric generator and to feed the servomotor with electric power; and a control part configured to control respective operations of the clutch, the servomotor, and the electric generator, wherein the control part is configured to perform such control as to cause the electric generator to generate the electricity with rotation of the drive shaft and to store the generated electricity in the electricity storage part during at least one of the rotation of the drive shaft with driving of the flywheel and the rotation of the drive shaft with an inertial force.

According to this configuration, it is possible to drive the servomotor using the electricity stored in the electricity storage part, so that it is possible to reduce the capacity of an external power supply for driving the servomotor, thus enabling realistic designing. Further, the electric generator converts an excess rotational energy of the flywheel or the inertial energy of the driven system into electricity. Therefore, it is possible to make efficient use of energy in the forging press as a whole.

The control part may perform such control as to cause the electric generator to generate the electricity with the rotation of the drive shaft and to store the generated electricity in the electricity storage part during lowering of the slide caused by the rotation of the drive shaft with the driving of the flywheel.

According to this configuration, it is possible to convert an excess rotational energy of the flywheel into electricity and to store the electricity when causing the slide to lower. Therefore, it is possible to make efficient use of energy in the forging press as a whole.

The control part may perform such control as to cause the electric generator to generate the electricity with the rotation of the drive shaft and to store the generated electricity in the electricity storage part during rising of the slide caused by the rotation of the drive shaft with the driving of the flywheel or during the rising of the slide caused by the rotation of the drive shaft with the inertial force.

According to this configuration, it is possible to convert an excess rotational energy of the flywheel into electricity and to store the electricity when causing the slide to rise. Further, by converting the inertial energy of the driven system into electricity, it is possible to store the electricity while applying the brakes to the slide. Therefore, it is possible to make efficient use of energy in the forging press as a whole.

The control part may perform such control as to cause the electric generator to generate the electricity with the rotation of the drive shaft and to store the generated electricity in the electricity storage part during pressure forming performed by causing the drive shaft to rotate with the driving of the flywheel.

According to this configuration, it is possible to convert an excess rotational energy of the flywheel into electricity and to store the electricity when performing pressure forming. Further, it is possible to ensure a long period of time for electricity generation by the electric generator. Accordingly, an early recovery of the level of stored electricity of the electricity storage part is possible.

The control part may perform such control as to perform pressure forming by causing the drive shaft to rotate with driving of the servomotor by feeding the servomotor with the electric power from the electricity storage part.

According to this configuration, it is possible to drive the servomotor using the electricity stored in the electricity storage part, so that it is possible to reduce the capacity of an external power supply for driving the servomotor, thus enabling realistic designing. Further, since pressure forming is performed with the driving of the servomotor, it is possible to increase the pressing speed and to set the slide motion during pressure forming as desired.

The electric generator may be the servomotor.

According to this configuration, the necessity of providing an electric generator separately from the servomotor is eliminated. This makes it possible to make the forging press compact as a whole.

A method of controlling a forging press according to an aspect of the present invention, the forging press including a slide configured to have a die attached thereto, a drive shaft configured to cause the slide to rise and lower by rotating, a flywheel connected to the drive shaft via a clutch, a servomotor connected to the drive shaft, an electric generator connected to the drive shaft, and an electricity storage part configured to store the electricity generated by the electric generator and to feed the servomotor with electric power, includes causing the electric generator to generate the electricity with rotation of the drive shaft and storing the generated electricity in the electricity storage part during at least one of the rotation of the drive shaft with driving of the flywheel and the rotation of the drive shaft with an inertial force.

According to this configuration, it is possible to drive the servomotor using the electricity stored in the electricity storage part, so that it is possible to reduce the capacity of an external power supply for driving the servomotor, thus enabling realistic designing. Further, the electric generator converts an excess rotational energy of the flywheel or the inertial energy of the driven system into electricity. Therefore, it is possible to make efficient use of energy in the forging press as a whole.

The electric generator may be caused to generate the electricity with the rotation of the drive shaft and store the generated electricity in the electricity storage part during lowering of the slide caused by the rotation of the drive shaft with the driving of the flywheel.

According to this configuration, it is possible to convert an excess rotational energy of the flywheel into electricity and to store the electricity when causing the slide to lower. Therefore, it is possible to make efficient use of energy in the forging press as a whole.

The electric generator may be caused to generate the electricity with the rotation of the drive shaft and store the generated electricity in the electricity storage part during rising of the slide caused by the rotation of the drive shaft with the driving of the flywheel or during the rising of the slide caused by the rotation of the drive shaft with the inertial force.

According to this configuration, it is possible to convert an excess rotational energy of the flywheel into electricity and to store the electricity when causing the slide to rise. Further, by converting the inertial energy of the driven system into electricity, it is possible to store the electricity while applying the brakes to the slide. Therefore, it is possible to make efficient use of energy in the forging press as a whole.

The electric generator may be caused to generate the electricity with the rotation of the drive shaft and store the generated electricity in the electricity storage part during pressure forming performed by causing the drive shaft to rotate with the driving of the flywheel.

According to this configuration, it is possible to convert an excess rotational energy of the flywheel into electricity and to store the electricity when performing pressure forming. Further, it is possible to ensure a long period of time for electricity generation by the electric generator. Accordingly, an early recovery of the level of stored electricity of the electricity storage part is possible.

Pressure forming may be performed by causing the drive shaft to rotate with driving of the servomotor by feeding the servomotor with the electric power from the electricity storage part.

According to this configuration, it is possible to drive the servomotor using the electricity stored in the electricity storage part, so that it is possible to reduce the capacity of an external power supply for driving the servomotor, thus enabling realistic designing. Further, since pressure forming is performed with the driving of the servomotor, it is possible to increase the pressing speed and to set the slide motion during pressure forming as desired.

A description is given above of the forging press and the method of controlling a forging press based on the embodiments. All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A forging press, comprising:
a slide configured to have a die attached thereto;
a drive shaft configured to cause the slide to rise and lower by rotating;
a flywheel connected to the drive shaft via a clutch;
a servomotor connected to the drive shaft;
an electric generator connected to the drive shaft;
an electricity storage part configured to store the electricity generated by the electric generator and to feed the servomotor with electric power; and
a control part configured to control respective operations of the clutch, the servomotor, and the electric generator,
wherein the control part is configured to perform such control as to cause the electric generator to generate the electricity with rotation of the drive shaft and to store the generated electricity in the electricity storage part during at least one of the rotation of the drive shaft with driving of the flywheel and the rotation of the drive shaft with an inertial force.

2. The forging press as claimed in claim 1, wherein the control part is configured to perform such control as to cause the electric generator to generate the electricity with the rotation of the drive shaft and to store the generated electricity in the electricity storage part during lowering of the slide caused by the rotation of the drive shaft with the driving of the flywheel.

3. The forging press as claimed in claim 2, wherein the control part is configured to perform such control as to cause the electric generator to generate the electricity with the rotation of the drive shaft and to store the generated electricity in the electricity storage part during rising of the slide caused by the rotation of the drive shaft with the driving of the flywheel or during the rising of the slide caused by the rotation of the drive shaft with the inertial force.

4. The forging press as claimed in claim 3, wherein the control part is configured to perform such control as to cause the electric generator to generate the electricity with the rotation of the drive shaft and to store the generated electricity in the electricity storage part during pressure forming performed by causing the drive shaft to rotate with the driving of the flywheel.

5. The forging press as claimed in claim 3, wherein the control part is configured to perform such control as to perform pressure forming by causing the drive shaft to rotate with driving of the servomotor by feeding the servomotor with the electric power from the electricity storage part.

6. The forging press as claimed in claim 3, wherein the electric generator is the servomotor.

7. A method of controlling a forging press, the forging press including a slide configured to have a die attached thereto, a drive shaft configured to cause the slide to rise and lower by rotating, a flywheel connected to the drive shaft via a clutch, a servomotor connected to the drive shaft, an electric generator connected to the drive shaft, and an electricity storage part configured to store the electricity generated by the electric generator and to feed the servomotor with electric power, the method comprising:
causing the electric generator to generate the electricity with rotation of the drive shaft and storing the generated electricity in the electricity storage part during at least one of the rotation of the drive shaft with driving of the flywheel and the rotation of the drive shaft with an inertial force.

8. The method of controlling a forging press as claimed in claim 7, further comprising:
causing the electric generator to generate the electricity with the rotation of the drive shaft and storing the generated electricity in the electricity storage part during lowering of the slide caused by the rotation of the drive shaft with the driving of the flywheel.

9. The method of controlling a forging press as claimed in claim 8, further comprising:
causing the electric generator to generate the electricity with the rotation of the drive shaft and storing the generated electricity in the electricity storage part during rising of the slide caused by the rotation of the drive shaft with the driving of the flywheel or during the rising of the slide caused by the rotation of the drive shaft with the inertial force.

10. The method of controlling a forging press as claimed in claim 9, further comprising:
causing the electric generator to generate the electricity with the rotation of the drive shaft and storing the generated electricity in the electricity storage part during pressure forming performed by causing the drive shaft to rotate with the driving of the flywheel.

11. The method of controlling a forging press as claimed in claim 8, further comprising:
performing pressure forming by causing the drive shaft to rotate with driving of the servomotor by feeding the servomotor with the electric power from the electricity storage part.
